(19) United States
(12) Patent Application Publication
(10) Pub. No.: US 2006/0158325 A1
(43) Pub. Date: Jul. 20, 2006

(54) Management system and method using virtual SDR (sensor data record)

(75) Inventors: Jee-hye Cha, Seoul (KR); Seung-whan Kim, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/319,503

(22) Filed: Dec. 29, 2005

(30) Foreign Application Priority Data
Jan. 4, 2005 (KR) 2005-467

(51) Int. Cl. G08B 19/00; G06Q 99/00; G08B 1/00

(52) U.S. Cl. 340/521; 340/531; 705/1

(57) ABSTRACT

A management system and method using a virtual SDR (Sensor Data Record) which manages and provides monitoring information of sensors in a server system using the virtual SDR. The management system includes an SDR module that stores information of sensors in a server system, a DMISP (Desktop Management Interface Service Provider) module that generates respective sensor information tables for the sensors when the server system is initialized and requests monitoring information of the sensors at specified intervals, a CI (Component Instrumentation) module that reads the sensor information from the SDR module and stores the read sensor information in the generated sensor information tables, and a control chip that monitors the sensors and provides the monitoring information of the sensors according to a request from the DMISP module.

### CROSS-REFERENCE TO RELATED APPLICATIONS

This application claims the benefit of Korean Patent Application No. 2005-467 filed on Jan. 4, 2005, in the Korean Intellectual Property Office, the disclosure of which is incorporated herein by reference in its entirety.

### BACKGROUND OF THE INVENTION

1. Field of the Invention

The present invention relates to a management system and method using a virtual SDR (Sensor Data Record), and more particularly to a management system and method using a virtual SDR which can efficiently collect and manage monitoring information of sensors in a server system using the virtual SDR.

2. Description of the Related Art

A server system may be provided with a separate controller called a BMC (Baseboard Management Controller) which is added to the server system in the form of an on-board controller or an add-on card in order to manage the server system more efficiently. In the BMC, a separate storage area called an SDR (Sensor Data Record) is provided to store information obtained from sensors in the server system, such as a CPU temperature sensor, a fan speed sensor, a voltage sensor, etc.

The BMC monitors a state of the hardware of the server system using a standard protocol called IPMI (Intelligent Platform Management Interface), and stores information obtained from sensors in the system. More specifically, the BMC stores the information obtained from the sensors in the SDR, and the sensor information stored in the SDR complies with the IPMI standard.

Additionally, system management software communicates with the BMC located in hardware through the IPMI, and thus the server system can exchange hardware information (for example, basic information about the sensors, present sensor values, etc.) with the system management software.

However, the system management software cannot be used in a server system that does not have a BMC. This is because the system management software requires that the data structure of information obtained from sensors used in a DMISP (Desktop Management Interface Service Provider) and a CI (Component Instrumentation) which are part of the system management software and the data structure of various basic information about the server system comply with the IPMI standard, i.e., the SDR standard.

Accordingly, in order to use the above-described system management software in a server system that does not have a BMC, the system management software must be extensively modified to convert data of the server system that does not have a BMC into the IPMI data structure used in the system management software.

Additionally, routines for inputting information obtained from sensors in the server system that does not have a BMC must be added to the system management software, and this requires a lot of time and effort.

### SUMMARY OF THE INVENTION

Accordingly, the present invention addresses the above-mentioned problems occurring in the related art, and an aspect of the present invention is to provide a management system and method which can collect and manage monitoring information of sensors in a server system that does not have a BMC by generating a virtual SDR.

Another aspect of the present invention is to provide a management system and method which eliminates the need to modify system management software or write new system management software when a hardware configuration of a server system is changed by storing basic information about sensors in the server system and register information in the form of an SDR file and a register file, and changing the values stored in the SDR file and the register file whenever the hardware configuration is changed to values appropriate for use with the new hardware configuration.

In accordance with one aspect of the present invention, a management system using a virtual SDR (Sensor Data Record) includes an SDR module that stores information of sensors in a server system, a DMISP (Desktop Management Interface Service Provider) module that generates respective sensor information tables for the respective sensors when the server system is initialized and requests monitoring information of the sensors at specified intervals, a CI (Component Instrumentation) module that reads the sensor information from the SDR module and stores the read sensor information in the generated sensor information tables, and a control chip that monitors the sensors and provides the monitoring information of the sensors according to a request from the DMISP module.

In accordance with another aspect of the present invention, a management method using a virtual SDR (Sensor Data Record) includes requesting monitoring information of specified sensors, searching for the requested monitoring information of the specified sensors and transmitting the searched-for monitoring information, storing the transmitted monitoring information of the specified sensors in sensor information tables for the specified sensors, and searching for the monitoring information of a specified sensor in one of the sensor information tables that is for the specified sensor in response to a user's request and displaying the searched-for monitoring information of the specified sensor.

In accordance with another aspect of the present invention, a management system includes a virtual SDR (Sensor Data Record) module that stores information about sensors in a server system, a DMISP (Desktop Management Interface Service Provider) module that generates respective sensor information tables for the sensors when the server system is initialized, and a CI (Component Instrumentation) module that reads the information about the sensors from the virtual SDR module and stores the information about the sensors in the sensor information tables.

In accordance with another aspect of the present invention, a management method includes storing information about sensors in a server system in a virtual SDR (Sensor Data Record) module, generating respective sensor information tables for the sensors when the server system is initialized, reading the information about the sensors from the virtual SDR module, and storing the information about the sensors in the sensor information tables.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating the internal construction of a management system using a virtual SDR according to an embodiment of the present invention;

FIG. 2 is a view illustrating a sensor information table generated and managed by a DMISP module and a CI module of a management system using a virtual SDR according to an embodiment of the present invention; and

FIG. 3 is a flowchart illustrating a management method using a virtual SDR according to another embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

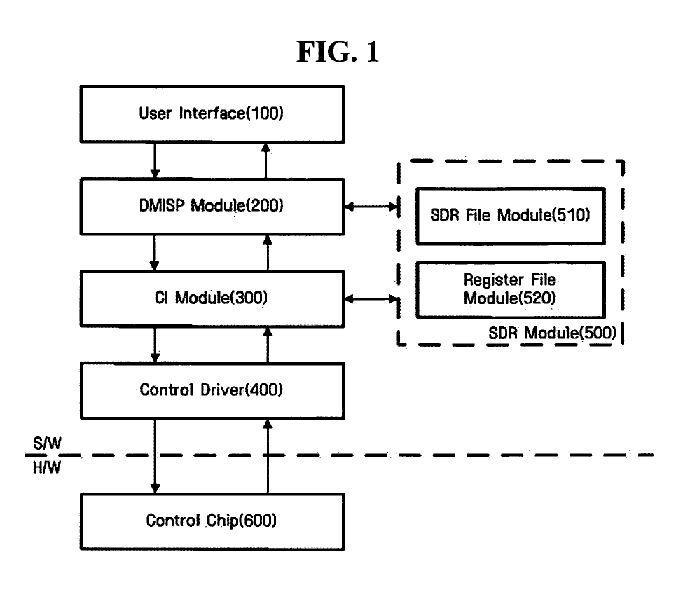

FIG. 1 is a block diagram illustrating the internal construction of a management system using a virtual SDR according to an embodiment of the present invention.

As illustrated in FIG. 1, the management system using a virtual SDR (Sensor Data Record) according to an embodiment of the present invention includes a user interface 100, a DMISP (Desktop Management Interface Service Provider) module 200, a CI (Component Instrumentation) module 300, a control driver 400, an SDR module 500, and a control chip 600.

The user interface 100 displays monitoring information of sensors in a server system, event notification messages relating to events occurring in the server system (for example, alarm messages), etc. The monitoring information may be a CPU temperature, a fan speed, a voltage, etc.

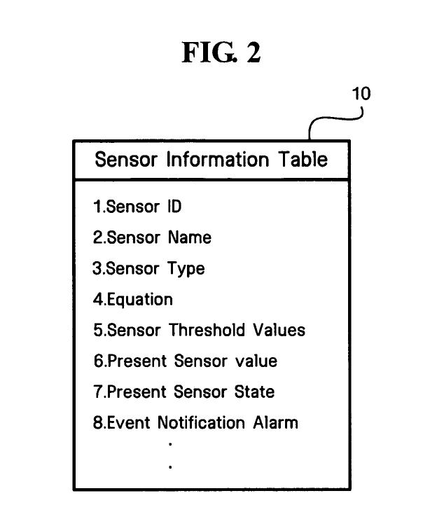

The DMISP module 200 generates respective sensor information 10 (see FIG. 2) for the sensors during initialization of the server system by a control module (not illustrated), and requests monitoring information of the sensors at specified intervals from the CI module 300.

Also, the DMISP module 200 updates the sensor information tables 10 with the monitoring information of the sensors which is received from the CI module 300. The sensor information tables 10 are stored in a memory module (not illustrated), and the DMISP module 200 and the CI module 300 store basic information about the sensors in the sensor information tables 10 stored in the memory module and update the monitoring information of the sensors stored in the sensor information tables 10. The sensor information tables 10 will be explained later with reference to FIG. 2.

Additionally, the DMISP module 200 displays the monitoring information of a specified sensor through the user interface 100 with reference to the sensor information table 10 for the specified sensor when a user requests the monitoring information of the specified sensor through the user interface 100.

The DMISP module 200 converts the monitoring information of the specified sensor which is stored in the sensor information table 10 for the specified sensor in the form of raw data into user data that can be recognized by the user interface 100, and transmits the user data to the user interface 100. Raw data means unprocessed data which cannot be recognized by the user interface 100, and user data means processed data which is obtained by converting the raw data and which can be recognized by the user interface 100.

The DMISP module 200 performs the data conversion according to an equation which is stored in the sensor information table 10 for the specified sensor. The equation depends on the sensor, and different sensors may have different equations.

For example, a temperature sensor may output a voltage which depends on a temperature of a part being monitored by the temperature sensor. A value representing this output voltage may be stored in a sensor information table 10 for the temperature sensor as raw data, and an equation expressing the temperature of the part in ° C. or ° F. as a function of the voltage may be stored in the sensor information table 10 for the temperature sensor.

As another example, a fan speed sensor may output a voltage which depends on a speed of the fan. A value representing this output voltage may be stored in a sensor information table 10 for the fan speed sensor as raw data, and an equation expressing the fan speed in RPM (revolutions per minute) as a function of the voltage may be stored in the sensor information table 10 for the fan speed sensor. Alternatively, the fan speed sensor may output one or more pulses for each rotation of the fan. The number of pulses output during a predetermined period may be stored in the sensor information table 10 for the fan speed sensor as raw data, and an equation expressing the fan speed in RPM (revolutions per minute) as a function of the number of pulses and the predetermined period may be stored in the sensor information table 10 for the fan speed sensor.

The CI module 300 reads the sensor information from the SDR module 500 and stores the read sensor information in the sensor information table 10 stored in the memory module (not illustrated). Additionally, the CI module 300 requests the monitoring information of the specified sensor from the control driver 400 in response to the request received from the DMISP module 200, and transmits the monitoring information of the specified sensor received from the control driver 400 to the DMISP module 200.

The control driver 400 receives the request for the monitoring information of the specified sensor from the CI module 300 and communicates with the control chip 600 through an IPMI (Intelligent Platform Management Interface) to obtain the monitoring information of the specified sensor.

For example, if the CI module 300 requests the monitoring information of the specified sensor, the control driver 400 transmits the request received from the CI module 300 to the control chip 600 through the IPMI, receives the monitoring information of the specified sensor in response to the request from the control chip 600 through the IPMI, and transmits the monitoring information of the specified sensor received from the control chip 600 to the CI module 300.

The SDR module 500 stores sensor information of the sensors in the server system, and includes an SDR file module 510 and a register file module 520. All sensor information stored in the SDR module 500 complies with the IPMI standard.

The SDR module 500 is a virtual SDR module that can collect and manage the monitoring information of the sensors even in a server system that has no BMC (Baseboard Management Controller), and may be placed in any part of the software of the server system.

Additionally, the SDR module 500 stores basic information about the sensors and register numbers in the form of an SDR file and a register file. Accordingly, when the hardware configuration of the server system is changed, it is not necessary to modify the system management software or write new system management software for use with the new hardware configuration. Rather, it is only necessary to change the values stored in the SDR file and the register file to values appropriate for use with the new hardware configuration.

More specifically, although the basic information about the sensors of the server system may be different for each different hardware configuration, it is not necessary to modify the system management software or write new system management software for use with each different hardware configuration. Rather, it is only necessary to prepare a new SDR file containing basic information about the sensors in the particular hardware configuration that is being used. Similarly, although the register numbers may be different for each different control chip 600, it is not necessary to modify the system management software or write new system management software for each hardware configuration using a different control chip 600. Rather, it is only necessary to prepare a new register file containing register numbers for the particular control chip 600 being used.

The SDR file module 510 stores the number of the sensors that are subject to management among the sensors in the server system and basic information about the sensors that are subject to management. The basic information about the sensors stored in the SDR file module 510 may be a sensor ID, a sensor type, a sensor name, sensor threshold values, a sensor value marking unit, a sensor value error permission range, etc.

The register file module 520 stores register numbers assigned to pins of the control chip 600 in the form of a file. The information stored in the register file module 520 may be sensor IDs, register numbers for indicating sensor states, register numbers for reading sensor values, register numbers for reading various kinds of threshold values, etc.

As discussed above, the use of the register file module 520 makes it unnecessary to modify the system management software or write new system management software due to the register numbers being different for each different control chip 600.

The control chip 600 monitors states of the sensors in the server system, and provides the monitoring information of specified sensors in response to requests received from the control driver 400. Pins of the control chip 600 are connected to the sensors so that the control chip 600 can read the monitoring information of the sensors through the pins.

FIG. 2 is a view illustrating the sensor information table 10 generated and managed by the DMISP module 200 and the CI 300 module of the management system using a virtual SDR according to an embodiment of the present invention.

As illustrated in FIG. 2, the sensor information table 10 stores sensor information such as a sensor ID, a sensor name, a sensor type, an equation, sensor threshold values, a present sensor value, a present sensor state, an event notification alarm, etc. A sensor information table 10 is generated for each sensor.

First, the DMISP module 200 generates sensor information tables 10 for the sensors in the server system. Then, the CI module 300 reads out basic information about the sensors from the SDR module 500 and stores the basic information in the sensor information tables 10 generated by the DMISP module 200.

For example, if the DMISP module 200 generates a sensor information table 10 for sensor ‘A’, the CI module 300 reads the basic information about sensor ‘A’ from the SDR file module 510 and the register file module 520 and stores the basic information about sensor ‘A’ in the sensor information table 10 for sensor ‘A’. The basic information may be a sensor ID, a sensor type, a sensor name, register numbers for reading threshold values and sensor values, a unit for reading sensor values, etc.

Then, the DMISP module 200 requests monitoring information of sensor ‘A’ (for example, the present state information of sensor ‘A’) from the CI module 300 at predetermined intervals. Accordingly, the CI module 300 requests the monitoring information of the specified sensor requested by the DMISP module 200 from the control driver 400, and the control driver 400 requests the monitoring information of the specified sensor from the control chip 600 through the IPMI.

The control chip 600 transmits the monitoring information of the specified sensor to the control driver 400 through the IPMI in response to the request received from the control driver 400, and the control driver 400 transmits the monitoring information of the specified sensor received from the control chip 600 to the CI module 300. The CI module 300 transmits the monitoring information of the specified sensor received from the control driver 400 to the DMISP module 200.

The DMISP module 200 stores the monitoring information of the specified sensor received from the CI module 300 (for example, the present state information of sensor ‘A’) in the sensor information table 10. The DMISP module 200 requests the monitoring information of the specified sensor at predetermined intervals, and thus the monitoring information of the specified sensor stored in the sensor information table 10 is updated at the predetermined intervals. The monitoring information stored in the sensor information table 10 is stored in the form of raw data.

Additionally, if a user requests the monitoring information of a specified sensor through the user interface 100, the DMISP module 200 searches for the monitoring information of the specified sensor in the sensor information table 10 for the specified sensor and displays the searched-for monitoring information of the specified sensor on a display screen through the user interface 100.

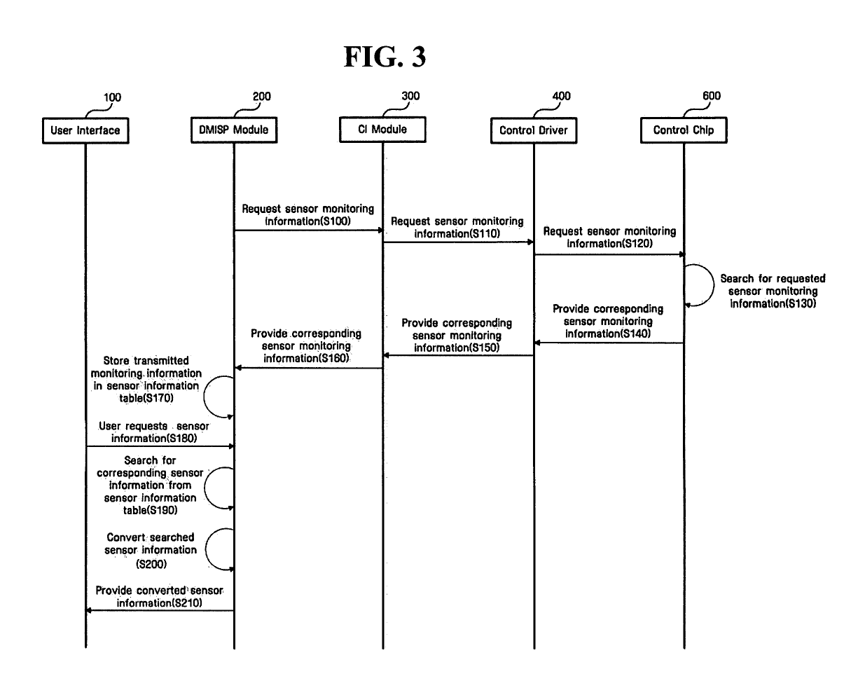

FIG. 3 is a flowchart illustrating a management method using a virtual SDR according to another embodiment of the present invention.

As illustrated in FIG. 3, if the control module (not illustrated) initializes the server system, the control driver 400 is loaded, and the DMISP module 200 generates the sensor information tables 10 for the sensors in the server system.

The CI module 300 reads the basic information about the sensors from the SDR module 500 and stores the basic information in the sensor information tables 10. The basic information may be a sensor ID, a sensor type, a sensor name, register numbers for reading threshold values and sensor values, a unit for reading sensor values, etc.

Then, the DMISP module 200 requests monitoring information of a specified sensor from the CI module 300 (operation S100). For example, the monitoring information may be the present value and the present state of the specified sensor, and the present state of the sensor may be a normal state, or a non-dangerous state, or a dangerous state.

Additionally, the DMISP module 200 transmits a register number corresponding to the specified sensor in addition to a request for the monitoring information of the specified sensor when the DMISP module 200 requests the monitoring information of the specified sensor is requested to enable the control chip 600 to search for and transmit the monitoring information of the specified sensor using the transmitted register number.

Then, the CI module 300 requests the monitoring information of the specified sensor from the control driver 400 (operation S110), and the control driver 400 requests the monitoring information of the specified sensor from the control chip 600 through the IPMI (operation S120).

The control chip 600 searches for the monitoring information of the specified sensor in response to the request received from the control driver 400 (operation S130) using the register number received together with the request for the monitoring information of the specified sensor.

Then, the control chip 600 transmits the monitoring information of the specified sensor to the control driver 400 through the IPMI (operation S140), and the control driver 400 transmits the monitoring information of the specified sensor received from the control chip 600 to the CI module 300 (operation S150).

Then, the CI module 300 transmits the monitoring information of the specified sensor received from the control driver 400 to the DMISP module 200 (operation S160). Then, the DMISP module 200 stores the monitoring information of the specified sensor received from the CI module 300 in the sensor information table 10 (operation S170).

Operations S100 to S170 are repeatedly performed at predetermined intervals, and thus the sensor information (for example, the present sensor value, the present sensor state, etc.) of the sensor information table 10 is updated at the predetermined intervals.

If the user requests the monitoring information of a specified sensor through the user interface 100 (operation S180), the DMISP module 200 searches for the monitoring information of the specified sensor requested by the user in the sensor information table 10 for the specified sensor (operation S190), and converts the searched-for monitoring information of the specified sensor, which is stored in the sensor information table 10 as raw data, into user data that can be recognized by the user interface 100 according to the equation stored in the sensor information table 10 (operation S200). The reason why the raw data is converted into the user data is that the user interface 100 cannot recognize the raw data but can recognize the user data.

Then, the DMISP module 200 displays the user data through the user interface 100 (operation S210).

Accordingly, the present invention can efficiently perform system management by requesting monitoring information of a specified sensor based on a sensor information table stored in a virtual SDR at predetermined intervals and by updating the sensor information table with the monitoring information of the specified sensor received according to the request.

As described above, a management system and method using a virtual SDR according to the present invention has at least one of the following effects.

First, monitoring information of sensors in a server system that does not have a BMC can be collected and managed using system management software developed for a server system having a BMC.

Second, the need to modify system management software or write new system management software when a hardware configuration of the server system is changed is eliminated by storing basic information about the sensors and register information in the form of an SDR file and a register file, and changing the values stored in the SDR file and the register file whenever the hardware configuration is changed to values appropriate for use with the new hardware configuration.

Third, the server system can efficiently be managed by managing the monitoring information of the sensors of the server system using a virtual SDR.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A management system using a virtual SDR (Sensor Data Record), comprising:
an SDR module that stores sensor information of sensors in a server system;
a DMISP (Desktop Management Interface Service Provider) module that generates respective sensor information tables for the sensors when the server system is initialized and requests monitoring information of the sensors at specified intervals;
a CI (Component Instrumentation) module that reads the sensor information from the SDR module and stores the read sensor information in the generated sensor information tables; and
a control chip that monitors the sensors and provides the monitoring information of the sensors according to a request from the DMISP module.

2. The management system of claim 1, wherein the DMISP module updates the sensor information tables with the monitoring information of the sensors provided by the control chip according to the request from the DMISP module.

3. A management method using a virtual SDR (Sensor Data Record), comprising:
requesting monitoring information of specified sensors;
searching for the requested monitoring information of the specified sensors and transmitting the searched-for monitoring information of the specified sensors;
storing the transmitted monitoring information of the specified sensors in sensor information tables for the specified sensors; and
searching for the monitoring information of the specified sensor in one of the sensor information tables that is for the specified sensor in response to a user's request and displaying the searched-for monitoring information of the specified sensor.

4. The management method of claim 3, further comprising:
generating the sensor information tables for the specified sensors when a server system comprising the specified sensors is initialized; and
reading basic information about the specified sensors and storing the read basic information in the generated sensor information tables.

5. The management method of claim 3, wherein the monitoring information of the specified sensors is requested at predetermined intervals.

6. A management system comprising:
a virtual SDR (Sensor Data Record) module that stores information about sensors in a server system;
a DMISP (Desktop Management Interface Service Provider) module that generates respective sensor information tables for the sensors when the server system is initialized; and
a CI (Component Instrumentation) module that reads the information about the sensors from the virtual SDR module and stores the information about the sensors in the sensor information tables.

7. The management system of claim 6, wherein the server system does not comprise a BMC (Baseboard Management Controller).

8. The management system of claim 6, wherein the information about the sensors stored in the virtual SDR module complies with an IPMI (Intelligent Platform Management Interface) standard.

9. The management system of claim 6, further comprising a control chip that reads monitoring information of a specified sensor of the sensors in the server system in response to a request for the monitoring information of the specified sensor, and outputs the monitoring information of the specified sensor;
wherein the DMISP module transmits the request for the monitoring information of the specified sensor to the control chip, receives the monitoring information of the specified sensor from the control chip, and stores the monitoring information of the specified sensor in one of the sensor information tables corresponding to the specified sensor.

10. The management system of claim 9, wherein the DMISP module transmits the request for the monitoring information of the specified sensor to the control chip at predetermined intervals.

11. The management system of claim 9, further comprising a user interface that transmits a request for monitoring information of a specified sensor of the sensors in the server system to the DMISP module in response to a user's request for the monitoring information of the specified sensor made via the user interface;
wherein the DMISP module reads the monitoring information of the specified sensor from one of the sensor information tables corresponding to the specified sensor in response to the request for the monitoring information of the specified sensor from the user interface, and transmits the monitoring information for the specified sensor to the user interface; and
wherein the user interface displays the monitoring information of the specified sensor read from the sensor information table corresponding to the specified sensor.

12. The management system of claim 6, wherein the virtual SDR module comprises:
an SDR file module that stores an SDR file containing information about the sensors in the server system; and
a register file module that stores a register file containing register information relating to the sensors in the server system.

13. A management method comprising:
storing information about sensors in a server system in a virtual SDR (Sensor Data Record) module;
generating respective sensor information tables for the sensors when the server system is initialized;
reading the information about the sensors from the virtual SDR module; and
storing the information about the sensors in the sensor information tables.

14. The management method of claim 13, wherein the server system does not comprise a BMC (Baseboard Management Controller).

15. The management method of claim 13, wherein the information about the sensors stored in the virtual SDR module complies with an IPMI (Intelligent Platform Management Interface) standard.

16. The management method of claim 13, further comprising:
reading monitoring information of a specified sensor of the sensors in the server system in response to a request for the monitoring information of the specified sensor; and
storing the monitoring information of the specified sensor in one of the sensor information tables corresponding to the specified sensor.

17. The management method of claim 16, wherein the request for the monitoring information of the specified sensor occurs at predetermined intervals.

18. The management method of claim 16, further comprising:
reading monitoring information of a specified sensor of the sensors in the server system from one of the sensor information tables corresponding to the specified sensor in response to a user's request for the monitoring information of the specified sensor made via a user interface; and
displaying the monitoring information of the specified sensor read from the sensor information table corresponding to the specified sensor via the user interface.

19. The management method of claim 13, wherein the virtual SDR module comprises:
an SDR file module that stores an SDR file containing information about the sensors in the server system; and
a register file module that stores a register file containing register information relating to the sensors in the server system.
